(19) United States
(12) Patent Application Publication
(10) Pub. No.: US 2012/0284782 A1
(43) Pub. Date: Nov. 8, 2012

(54) Method and system for facilitating secure electronic transactions

(76) Inventors: Hakim Abdul Karim, Sheung Wan (CN); Raul Abreu Dominguez, Tung Chung (CN)

(21) Appl. No.: 13/101,799

(22) Filed: May 5, 2011

(51) Int. Cl. H04L 9/32

(52) U.S. Cl. 726/6

(57) ABSTRACT

A computer-implemented method for securing data and facilitating transactions. The method including the steps of collecting data from a sender party into a memory of a computer and generating an encrypted code representative of the sender party data stored in the memory of the computer. A graphic image representative of the encrypted code in the computer is generated and is provided from the computer to the sender party. The generated graphic image is then captured in an electronic device associated with a recipient party that the sender party desires to perform a transaction with whereafter the generated graphic image or the encrypted code it represents is transmitted from the recipient party electronic device to the computer to perform the transaction with the sender party.

### FIELD OF THE INVENTION

The present invention relates to a system and method for managing and securing information, and more particularly, to a system and method for managing and facilitating electronic transactions in a secure manner amongst electronic devices.

### BACKGROUND OF THE INVENTION

There are numerous known methods for securely exchanging information or performing transactions electronically between two or more parties, but they often require special software particular to the device (i.e. a bespoke application generally required by both parties to perform the transaction) and/or cumbersome/slow connection methods such as infrared or Bluetooth. Many also require an active Internet or VPN connection to perform the operation which can be difficult in areas such as developing and rural markets where Internet connectivity, unlike for example mobile telephone connectivity, may be rare, unreliable, slow and/or expensive. Also, given the variety of devices on the market, with individuals increasingly possessing multiple devices, there is no standard “lowest common denominator” mechanism for the transfer of information or the execution of transactions. In addition, much effort is being expended on having the intelligence to perform the transaction on the device(s) and is therefore dependent on “smart” devices such as smart phones (e.g. the Apple iPhone or Google Android devices), and may mean that the transaction is not captured at the network level where it can be analyzed in the aggregate as well as better protected.

Accordingly, it is an objective of the present invention to provide a system and method for managing and securing data and facilitating secure transactions via a third party.

### SUMMARY OF THE INVENTION

The invention merely requires the “receiver” of the information to have a device which can electronically capture and transmit an image, or the underlying encrypted code that the image represents, wherein the “sender” merely needs to display, or otherwise provide access to, the image or the underlying encrypted code that the image represents. To ensure that the image or the underlying code can only be used by the sender, said image or underlying encrypted code, is specific to a particular uniquely addressable electronic device under the control of the sender which can be used, if desired, to confirm the transaction. An additional level of security is provided by ensuring that the encrypted code and resulting image are specific to the time that they were created so that underlying information can be expired or updated. Thus, the invention standardizes and simplifies the communication of information requiring the use of readily available devices without the need for additional software on a sender or receiver device. In addition, since this method is standardized across all forms of transactions, users do not need to learn multiple paradigms and can aggregate all relevant information for any transaction type (e.g. all their personal information) in one place that is easy to maintain.

In one aspect, a computer method and system is described in which an aspect of the invention includes collecting data from a sender party into a memory of a computer and generating an encrypted code representative of the sender party data stored in the memory of the computer. A graphic image representative of the encrypted code in the computer is generated and is provided from the computer to the sender party. The generated graphic image is then captured in an electronic device associated with a recipient party that the sender party desires to perform a transaction with whereafter the generated graphic image is transmitted from the recipient party electronic device to the computer to perform the transaction with the sender party.

### BRIEF DESCRIPTION OF THE DRAWINGS

The objects and features of the invention can be understood with reference to the following detailed description of an illustrative embodiment of the present invention taken together in conjunction with the accompanying drawings in which:

FIG. 1 is a block diagram of a computer system that can be used with certain embodiments of the invention;

FIG. 2 is a system level diagram depicting the general operating environment and components of the invention in accordance with an illustrated embodiment; and

FIG. 3 is a flow diagram depicting operation of the invention in accordance with an illustrated embodiment.

### WRITTEN DESCRIPTION OF CERTAIN EMBODIMENTS OF THE INVENTION

The present invention is now described more fully with reference to the accompanying drawings, in which an illustrated embodiment of the present invention is shown. The present invention is not limited in any way to the illustrated embodiment as the illustrated embodiment described below is merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

It is to be appreciated the embodiments of this invention as discussed below are preferably a software algorithm, program or code residing on computer useable medium having control logic for enabling execution on a machine having a computer processor. The machine typically includes memory storage configured to provide output from execution of the computer algorithm or program.

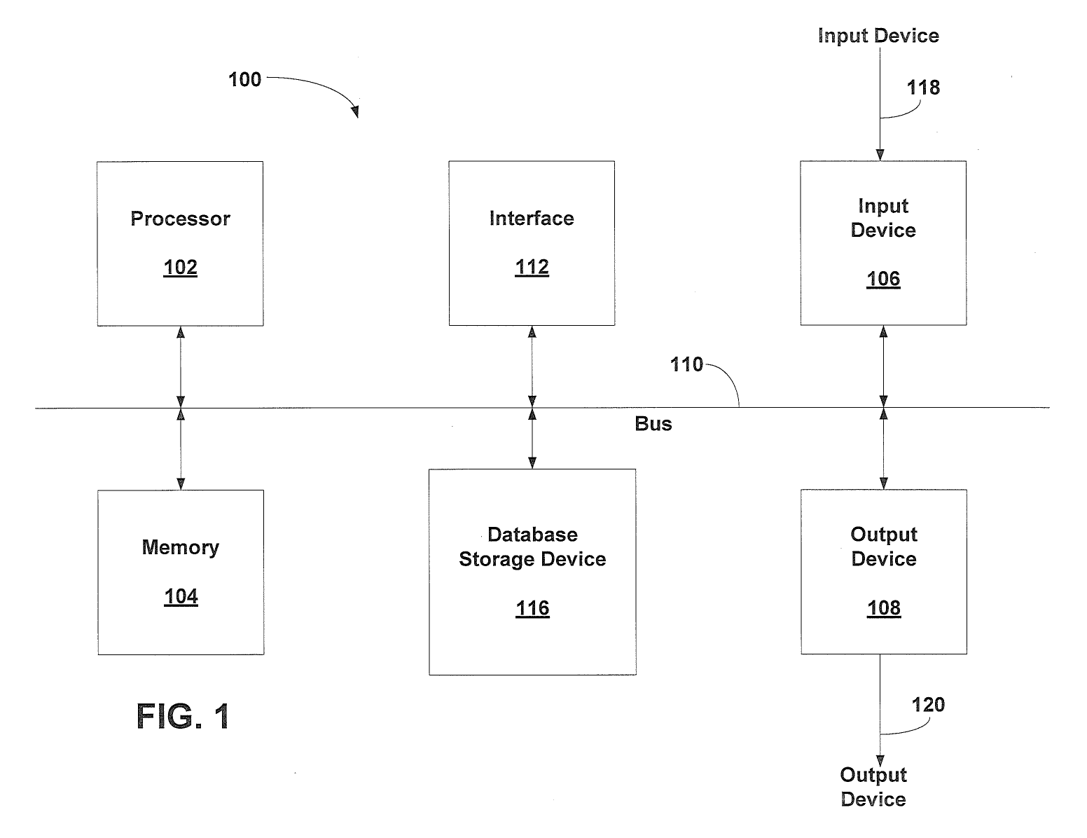

Turning now descriptively to the drawings, in which similar reference charters denote similar elements throughout the several views, FIG. 1 depicts an exemplary general-purpose computing system in which illustrated embodiments of the present invention may be implemented.

A generalized computering embodiment in which the present invention can be realized is depicted in FIG. 1 illustrating a processing system 100 which generally comprises at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 can also be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could comprise more than one distinct processing device, for example to handle different functions within the processing system 100. Input device 106 receives input data 118 and can comprise, for example, a keyboard, a pointer device such as a pen-like device or a mouse, audio receiving device for voice controlled activation such as a microphone, data receiver or antenna such as a modem or wireless data adaptor, data acquisition card, etc. Input data 118 could come from different sources, for example keyboard instructions in conjunction with data received via a network. Output device 108 produces or generates output data 120 and can comprise, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, at least one database 116. The interface 112 may allow wired and/or wireless communication between the processing unit 102 and peripheral components that may serve a specialized purpose. Preferably, the processor 102 receives instructions as input data 118 via input device 106 and can display processed results or other output to a user by utilizing output device 108. More than one input device 106 and/or output device 108 can be provided. It should be appreciated that the processing system 100 may be any form of terminal, server, specialized hardware, or the like.

It is to be appreciated that the processing system 100 may be a part of a networked communications system: Processing system 100 could connect to a network, for example the Internet or a WAN. Input data 118 and output data 120 could be communicated to other devices via the network. The transfer of information and/or data over the network can be achieved using wired communications means or wireless communications means. A server can facilitate the transfer of data between the network and one or more databases. A server and one or more databases provide an example of an information source.

Thus, the processing computing system environment 100 illustrated in FIG. 1 may operate in a networked environment using logical connections to one or more remote computers. The remote computer may be a personal computer, a server, a router, a network PC, a peer device, or other common network node, and typically includes many or all of the elements described above.

It is to be further appreciated that the logical connections depicted in FIG. 1 include a local area network (LAN) and a wide area network (WAN), but may also include other networks such as a personal area network (PAN). Such networking environments are commonplace in offices, enterprise-wide computer networks, intranets, and the Internet. For instance, when used in a LAN networking environment, the computing system environment 100 is connected to the LAN through a network interface or adapter. When used in a WAN networking environment, the computing system environment typically includes a modem or other means for establishing communications over the WAN, such as the Internet. The modem, which may be internal or external, may be connected to a system bus via a user input interface, or via another appropriate mechanism. In a networked environment, program modules depicted relative to the computing system environment 100, or portions thereof, may be stored in a remote memory storage device. It is to be appreciated that the illustrated network connections of FIG. 1 are exemplary and other means of establishing a communications link between multiple computers may be used.

FIG. 1 is intended to provide a brief, general description of an illustrative and/or suitable exemplary environment in which embodiments of the below described present invention may be implemented. FIG. 1 is an example of a suitable environment and is not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

In the description that follows, certain embodiments may be described with reference to acts and symbolic representations of operations that are performed by one or more computing devices, such as the computing system environment 100 of FIG. 1. As such, it will be understood that such acts and operations, which are at times referred to as being computer-executed, include the manipulation by the processor of the computer of electrical signals representing data in a structured form. This manipulation transforms the data or maintains them at locations in the memory system of the computer, which reconfigures or otherwise alters the operation of the computer in a manner understood by those skilled in the art. The data structures in which data is maintained are physical locations of the memory that have particular properties defined by the format of the data. meant to be limiting as those of skill in the art will appreciate that the acts and operations described hereinafter may also be implemented in hardware.

Embodiments may be implemented with numerous other general-purpose or special-purpose computing devices and computing system environments or configurations. Examples of well-known computing systems, environments, and configurations that may be suitable for use with an embodiment include, but are not limited to, personal computers, handheld or laptop devices, personal digital assistants, multiprocessor systems, microprocessor-based systems, set top boxes, programmable consumer electronics, network, minicomputers, server computers, game server computers, web server computers, mainframe computers, and distributed computing environments that include any of the above systems or devices.

Embodiments may be described in a general context of computer-executable instructions, such as program modules, being executed by a computer. Generally, program modules include routines, programs, objects, components, data structures, etc., that perform particular tasks or implement particular abstract data types. An embodiment may also be practiced in a distributed computing environment where tasks are performed by remote processing devices that are linked through a communications network. In a distributed computing environment, program modules may be located in both local and remote computer storage media including memory storage devices.

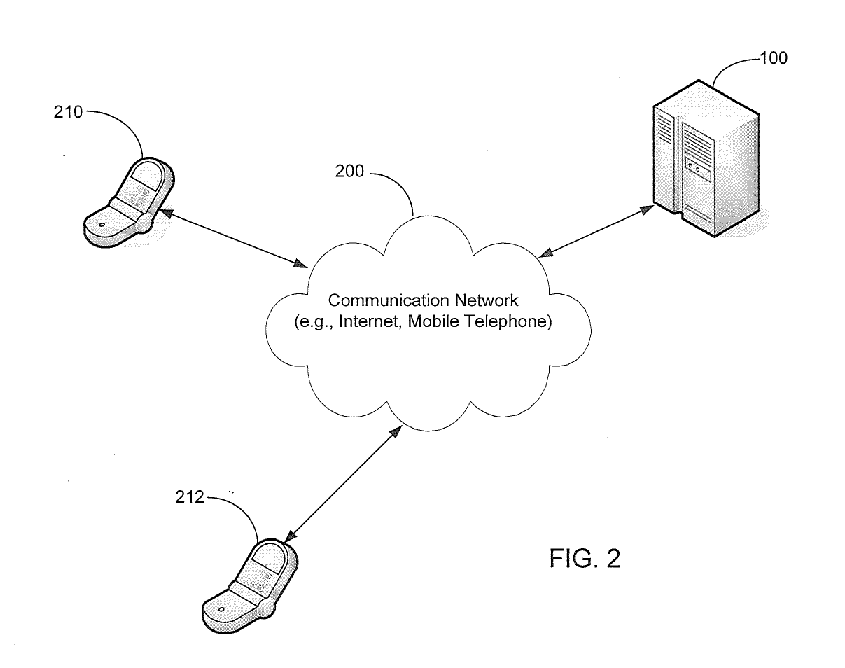

With the exemplary computing system environment 100 of FIG. 1 being generally shown and discussed above, reference is now made to FIG. 2 (with continuing reference to FIG. 1) illustrating the operating environment and generalized components of the invention. System 100 is preferably connected to a communication system/network 200 (such as, but not limited to, the Internet or a telephone system) through any known means. A sender and sender electronic communication device, represented by reference numeral 210, connects to the system 100 through any known electronic communication means, such as via the communication system/network 200. Likewise, a receiver and receiver electronic communication device, represented by reference numeral 212, connects to the system 100 through any known electronic communication system/network 200. It is to be understood and appreciated, system 100 is only shown as being coupled to a single sender and sender electronic communication device 210 and receiver and receiver electronic communication device 212 for clarity of illustration purposes as system 100 is to be understood to be simultaneously coupled to a plurality of sender and sender electronic communication devices 210 and receiver and receiver electronic communication devices 212. It is further to be appreciated and understood that for descriptive and illustrative purposes, each sender electronic communication device 210 and receiver electronic communication device 212 is referenced herein as a mobile telephone device which preferably includes a camera component. However, each sender electronic communication device 210 and receiver electronic communication device 212 is not to be understood to be limited to such as mobile telephone device but rather may consist of a smart phone device (e.g., Apple iPhone, Android phone, Windows phone and the like) or any other electronic communication device capable of performing the required functionality of the invention.

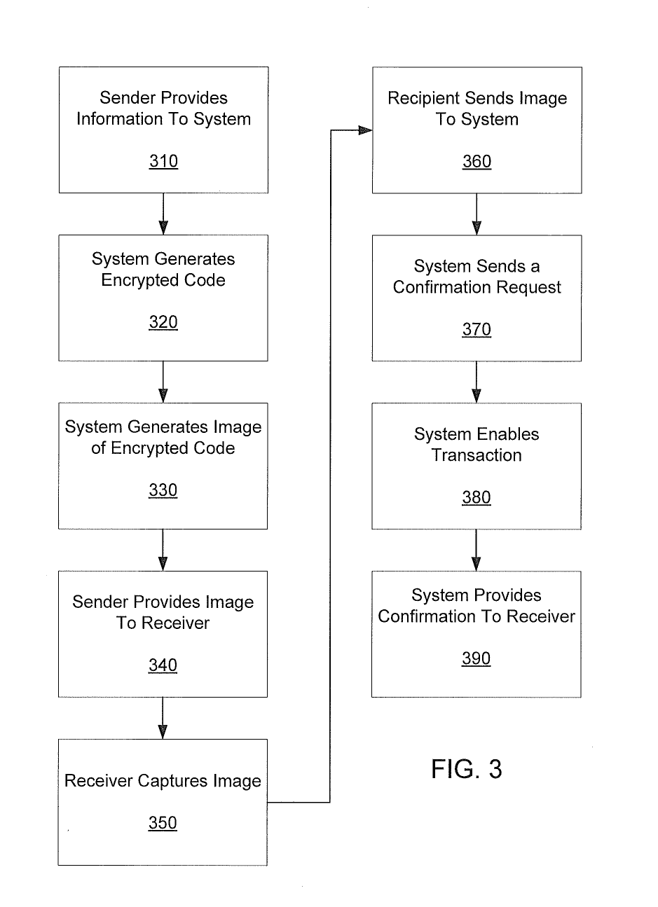

With a generalized description of the components of the invention described above, its method of operation will now be discussed. With reference now to FIG. 3 (and with continuing reference to FIGS. 1 and 2) and starting at step 300, the sender 210, or a trusted representative of the sender (e.g. the sender's 210 bank or employer), provides information to the system (e.g., via a website interface, smart phone app or API) to preferably provide profile information such as their name(s), e-mail addresses, social network (e.g. Linkedln or Facebook) profiles, credit card/banking details, etc. to which they desire to share with a receiver 212. The system 100 then preferably securely stores the aforesaid sender information in a memory component or medium. It is to be appreciated and understood the sender 210 may also indicate to system 100 whether the aforesaid information is confidential and therefore requires confirmation by the sender 210 upon delivery to the receiver 212.

Next, the system 100 preferably generates an encrypted code associated with the aforesaid sender information stored in system 100, which system will also store the date and time the data was stored to enable the information to be changed over time and to monitor any usage of the older data for security and alerting purposes. It is to be appreciated and understood this encrypted code is specific to the aforesaid sender's 210 information stored in system 100, to the sender's registered device 210 (e.g., a cell phone number) that is to be associated with this sender information and the date & time that was specified. It is further to be appreciated and understood, the generated encrypted code preferably only represents a link or key to the sender's aforesaid information stored in system 100, or via an API to another trusted system, and does not actually contain such sender information. In the illustrated embodiment, the system 100 then preferably generates an image to represent the encrypted code (such as a QR code) configured and operative such that the sender 210 can save it to a file, print it out or have the system 100 electronically send it to their registered sender device 210 (step 330). That is, the generated image is effectively a carrier used to convey the encrypted code from the sender 210 to a receiver device 212 and the invention is not to be understood to be limited to using an image to convey the encrypted code to a receiver device 212 as any means for conveying the encrypted code to a receiver device 212 enabling the functionality of the invention may be embodied by the invention.

In use, when the sender 210 desires to perform a transaction with a receiver 212 using the stored sender information from step 310 (e.g., transferring contact information, connecting on social networks, electronically transmitting money, etc.) the sender 210 causes the sender's device 210 to preferably display (such as on their mobile device) the image of the encrypted code generated in step 330 to preferably the receiver's device 212, which image of the encrypted code is again a link to the sender information stored in system 100 (step 340). It is to be appreciated and understood the invention is not to be limited to using a sender device 210 to display the aforesaid image of the encrypted code to the receiver 212, but rather the sender may use any means capable of displaying the aforesaid image or the encrypted code to the receiver 212 (e.g., email, facsimile, paper print out, etc.).

After the sender 210 displays and/or makes available the image of the encrypted code associated with the sender's aforesaid information stored in system 100 to which the sender 210 desires to make available to the receiver 212, the recipient preferably captures the image of the encrypted code preferably using the recipients electronic device 212 (e.g., mobile phone camera) (step 350). The receiver 212 then preferably sends the captured image or the underlying encrypted code securely to a predetermined address associated with system 100 (e.g., phone number using MMS or SMS, an Internet site, etc.) (step 360). Upon receipt of the image of the encrypted code sent by the receiver 212, the system 100 is preferably operative and configured such that if the sender 210 had designated the information to be sensitive (step 310) then a request for confirmation message will be sent (e.g., via SMS) to the sender's electronic device 210 associated with the encrypted code whereby the sender 210 is at least notified that the receiver 212 is requesting access to the sender's 210 information stored in system 100 or the system may be configured and operative to provide other information (e.g., via SMS) to the sender 210 (e.g. amount of funds the sender 210 desires to transfer to the receiver 212) (step 370).

Next, at step 380, the system 100 then performs the desired transaction (e.g., using the gateway of the ultimate service provider such as the social network or a bank/credit card provider's API using the sender's 210 information provided in step 310). At step 390, the system 100 may be configured and operative to provide the receiver confirmation of the transaction (e.g., via SMS).

With the invention described above in accordance with the illustrated embodiments, what is an improved data security system wherein the use of a confirmation message ensures that a sender 210 is aware of when, and possibly where (if the information is available from the communications carrier), a receiver 212 of the sender's 210 information is requested. Additionally, the image of the encrypted code used in the transaction (e.g., a QR Code) cannot be decoded by a human (unlike, for example, a credit card number) and even if decoded by a machine can not be deciphered or made meaningful since it is both encrypted and references coded information that is only relevant in the system 100. Further, the system 100 may be configured and operative to generate a new code and corresponding image if it is learned the security for an existing image has been compromised (e.g. the system 100 generates a new image to represent an existing bank account or credit card details if it is learned that such information may have been compromised rather than issuing a new card or bank account (also an enormous cost and convenience/time saving)). The system 100 may be configured and operative to provide alert notifications when, and possibly where, the former generated image is being used. An additional feature of the invention is the transaction is performed at the “back-end”/server/network level of system 100 so the “intelligence” of the transaction and the information used to drive it is captured in one location and can be analyzed for marketing or other purposes.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

The above presents a description of a best mode contemplated for carrying out the present invention, in such full, clear, concise, and exact terms as to enable any person skilled in the art to which it pertains to make and use these systems and methods. The present invention is, however, susceptible to modifications and alternative method steps from those discussed above that are fully equivalent. Consequently, the present invention wireless is not limited to the particular embodiments disclosed. On the contrary, the present invention encompasses all modifications and alternative constructions and methods coming within the spirit and scope of the present invention.

The descriptions above and the accompanying drawings should be interpreted in the illustrative and not the limited sense. While the invention has been disclosed in connection with the preferred embodiment or embodiments thereof, it should be understood that there may be other embodiments which fall within the scope of the invention as defined by the following claims. Where a claim, if any, is expressed as a means or step for performing a specified function, it is intended that such claim be construed to cover the corresponding structure, material, or acts described in the specification and equivalents thereof, including both structural equivalents and equivalent structures, material-based equivalents and equivalent materials, and act-based equivalents and equivalent acts.

What is claimed is:

1. A computer-implemented method for securing data and facilitating transactions, said method comprising the steps of:
collecting a sender party's data into a memory of a computer;
generating an encrypted code associated with the sender party data stored in the memory of the computer;
generating a graphic image representative of the encrypted code in the computer;
providing the generated graphic image from the computer to the sender party;
capturing the generated graphic image in an electronic device associated with a recipient party that the sender party desires to perform a transaction with; and
transmitting the encrypted code from the recipient party electronic device to the computer to perform the transaction with the sender party.

2. The method as recited in claim 1 further including the step of providing a confirmation request from the computer to the sender party after the computer receives the generated graphic image or encrypted code from the recipient party electronic device.

3. The method as recited in claim 1 wherein the collecting data steps includes collecting data relating to profile information of the sender party which the sender party desires to share with a recipient party.

4. The method as recited in claim 3 wherein data of the sender party is selected from the group consisting of sender contact information, social network information, sender financial information, etc.

5. The method as recited in claim 1 wherein the step of generating an encrypted code includes embedding a unique-in-time address to the sender party data stored in memory of the computer.

6. The method as recited in claim 1 wherein the step of generating a graphic image such as a Quick Response (QR) code.

7. The method as recited in claim 1 wherein the step of providing the generated graphic image from the computer to the sender party includes electronically transmitting the generated graphic image to a sender's device.

8. The method as recited in claim 1 wherein the step of capturing the generated graphic image in an electronic device associated with a recipient party includes using a camera device on an electronic device associated with a recipient party to capture and store in memory the generated graphic image and transmit it to the system.

9. A computer-implemented method for securing data and facilitating transactions, said method comprising the steps of:
generating an encrypted code associated with sender party data stored in the memory of the computer;
providing the encrypted code to an electronic device associated with a recipient party that the sender party desires to perform a transaction with; and
transmitting the encrypted code from the recipient party electronic device to the computer to perform the desired transaction with the sender party.

10. The method as recited in claim 9 further including the step of providing a confirmation request from the computer to the sender party after the computer receives the encrypted code from the recipient party electronic device.

11. The method as recited in claim 9 wherein the collecting data steps includes collecting data relating to profile information of the sender party which the sender party desires to share with a recipient party.

12. The method as recited in claim 11 wherein data of the sender party is selected from the group consisting of sender contact information, social network information, sender financial information, etc.

13. The method as recited in claim 9 wherein the step of generating an encrypted code includes embedding a unique-in-time address to the sender party data stored in memory of the computer.

14. The method as recited in claim 9 further including the steps of:
generating a graphic image embodying the encrypted code in the computer;
providing the generated graphic image embodying the encrypted code from the computer to the sender party; and
capturing the generated graphic image in an electronic device associated with a recipient party that the sender party desires to perform a transaction with.

15. The method as recited in claim 14 wherein the generated graphic image is a Quick Response (QR) code.

16. The method as recited in claim 14 wherein the step of providing the generated graphic image from the computer to the sender party includes electronically transmitting the generated graphic image to a sender's mobile phone device.

17. The method as recited in claim 14 wherein the step of capturing the generated graphic image in an electronic device associated with a recipient party includes using a camera device on an electronic device associated with a recipient party to capture and store in memory the generated graphic image and transmit it to the system.

18. The method as recited in claim 1 wherein the step of transmitting the encrypted code from the recipient party electronic device to the computer to perform the transaction with the sender party includes sending the generated image from the recipient party electronic device to the computer.

19. The method as recited in claim 1 wherein the step of generating an encrypted code includes generating an encrypted code specific to a uniquely addressable device associated with the sender.

20. The method as recited in claim 1, further including the step of the computer being operative and configured to perform transactions desired by the sender after the transmitting the encrypted code step.
